(19) United States
(12) Patent Application Publication
(10) Pub. No.: US 2024/0068509 A1
(43) Pub. Date: Feb. 29, 2024

(54) COVERED ROLLER, AND COVERED ROLLER LIFESPAN DETECTION METHOD

(71) Applicants: SANWA TECHNO CO., LTD., Kobe-shi, Hyogo (JP); RISETEC CO., LTD., Kobe-shi, Hyogo (JP)

(72) Inventors: Susumu Shoji, Kobe-shi, Hyogo (JP); Kazuro Fukui, Kobe-shi, Hyogo (JP)

(73) Assignees: SANWA TECHNO CO., LTD., Kobe-shi, Hyogo (JP); RISETEC CO., LTD., Kobe-shi, Hyogo (JP)

(21) Appl. No.: 18/034,627

(22) PCT Filed: Oct. 28, 2021
(86) PCT No.: PCT/JP2021/039904

§ 371 Date: Nov. 9, 2023

(30) Foreign Application Priority Data
Oct. 29, 2020 (JP) 2020-181944

(51) Int. Cl. F16C 13/00; B65G 39/02

(52) U.S. Cl. CPC F16C 13/00; B65G 39/02; B65G 2203/04

(57) ABSTRACT

To achieve reduction in cost and improvement in productivity, to provide a covered roller at which the covering is adequately secured, and to provide a lifespan detection means therefor, a rotating body covered with a covering has a region at which an insertion member is inserted inside the rotating body such that the covering intervenes therebetween, a length of the covering is made to be greater than a width in a width (axial) direction of the rotating body that is covered with the covering, the covering being made to protrude beyond the rotating body, heat-shrinking in the radial direction of the covering due to application of heat, or contraction of the covering where the rotating body is covered with a covering that has stretchability in at least the radial direction and that has been made to be longer than the width of the rotating body that is covered with the covering so as to protrude beyond the rotating body, causing an inside circumferential length of an end portion of the covering in the region which has been made to protrude from the rotating body to be less than or equal to an inside circumferential length of an inside diameter of the rotating body, the protruding portion of the covering being folded back inside the rotating body, the insertion member being inserted inside the rotating body under at least press-fit conditions such that the covering intervenes therebetween, the covering being held to the rotating body surface, the roller which is employed being such that at least the rotating body, the covering, and the insertion member are made integral.

### TECHNICAL FIELD

The present application relates to a rotating roller that has a circular or semicircular rotating shaft and at which a rotating body surface which rotates is covered.

### BACKGROUND ART

Rollers at which the rotating body surface is covered with a covering have been used conventionally as rollers in conveyors and other such conveyor apparatuses, rollers in conveyor units in printing apparatuses, and so forth. Various methods have been proposed for causing the covering of such a roller or the like at which a rotating body surface is covered with a covering to be held thereby or secured thereto.

Covering support bodies and means for preventing dislocation of coverings have been proposed in the context of methods for holding and securing coverings (e.g., see Patent Reference Nos. 1 and 2). At these Patent References, as means for preventing dislocation of a covering and a support body for a covering, dislocation prevention making use of a gripping force, dislocation prevention making use of engagement of recesses and projections at knit fabric, dislocation prevention making use of engagement between protrusion-like regions or hook-like regions on a rotating support body and gaps in mesh at knit fabric constituting a covering, dislocation prevention in which the surface of a rotating support body is covered by an elastic body having a coefficient of friction higher than a coefficient of friction of knit fabric, and dislocation prevention making use of bonding making use of thermal fusing or bonding making use of pressure-sensitive adhesive or non-pressure-sensitive adhesive are described as such means. An example is also indicated in which the end portion of a covering is secured by means of a retainer ring.

Furthermore, a method has also been proposed in which a seamless tube is used to cover a roller core, following which the two ends of the seamless tube are pulled toward the two sides of the core such that the entire tube covers the core, and the two cut ends are tied, following which this is placed within an airbox, the temperature of which is set to 150° C., and allowed to stand for 5 minutes to cause the tube to undergo heat-shrinking, and after passage of a prescribed time, the two ends of the seamless tube are lined up with the two end of the core at the exterior of the ties, heat cutting being carried out to complete covering of the roller core by the seamless tube (see, for example, Patent Reference No. 3).

A method has also been proposed in which a cylindrical seamless-type nonwoven fabric sheet, the inside diameter of which is somewhat larger than the outside diameter of a rubber lining layer, is used to cover the exterior of the rubber lining layer, following which steam is used to cause this to undergo heating and compression (shrinking), such that the nonwoven fabric sheet is made to come into intimate contact with the rubber lining layer (see, for example, Patent Reference No. 4). Here, the excess length portion of the nonwoven fabric sheet is made to extend toward the exterior from the end portion in the axial direction of the roller core, thread being used to sew together said excess length portion so that the end portion of the roller core is enclosed within this excess length portion.

Moreover, a method has also been proposed in which the surface of a cylindrical hollow shell is covered with a seamless cylindrical sleeve made of woven cloth, and the open end portions of said sleeve made of woven cloth are folded back and tucked within the end portions of the shell, a pair of end caps being press-fit within the end portions of the shell so that the press-fit end caps cause the sleeve made of woven cloth to be held by the shell (see, for example, Patent Reference No. 5).

Moreover, regarding covered roller lifespan detection, a method has been proposed in which the colors of the first layer and the second layer at a roller covered with two rubber layers are varied, change in color due to wear of the rubber being detected by a sensor at another roller (see, for example, Patent Reference No. 6). Furthermore, as other covered roller lifespan detection methods, a method in which a pulse sensor is used to detect groove(s) at a grooved roller, and a method in which lifespan is detected when a sensor is blocked due to the change in outside diameter as a result of wear of a roller, have been proposed (see, for example, Patent Reference No. 6).

### PRIOR ART REFERENCES

### Patent References

Patent Reference No. 1: International Patent Application Publication No. 2015/072024
Patent Reference No. 2: International Patent Application Publication No. 2015/049808
Patent Reference No. 3: Japanese Patent Application Publication Kokai No. H10[1998]-204779
Patent Reference No. 4: Japanese Patent Application Publication Kokai No. 2011-207579
Patent Reference No. 5: Japanese Patent No. 2628777
Patent Reference No. 6: Japanese Patent Application Publication Kokai No. H07[1995]-172614
Patent Reference No. 7: Japanese Patent Application Publication Kokai No. 2008-050133

### SUMMARY OF INVENTION

### Problem to be Solved by Invention

At the aforementioned Patent Reference Nos. 1 and 2, while gripping force, engagement of recesses and projections at woven/knit fabric, engagement with protrusions, means making use of the coefficient of friction, and means making use of adhesion or thermal fusing are indicated as means for preventing dislocation of a covering and a support body for a covering, with respect to end retainer means there is description only of a retainer ring of the push nut type. However, not only because such means would require a shaft portion to retain the push nut, but also because there is a problem in that it would be difficult to achieve a pressing force such as would allow the covering to be adequately held thereby, improvement thereof has been sought.

Whereas the method described at Patent Reference No. 3 has a procedure in which following covering with a seamless tube, ties are used to tie the end portions, this is not conducive to mass production where many rollers are to be fabricated due to the existence of the tying operation, and whereas the method described at Patent Reference No. 4 is such that nonwoven fabric sheets are sewn together, this is complicated and is not conducive to mass production due to the existence of the operation in which these are sewn together, as a result of which each method requires improvement.

Whereas the method described at Patent Reference No. 5 is such that the surface of a cylindrical hollow shell is covered with a seamless cylindrical sleeve made of woven cloth, the open end portions of the sleeve made of woven cloth being folded back and tucked within the end portions of the shell, a pair of end caps being press-fit within the end portions of the shell, the press-fit end caps causing the sleeve made of woven cloth to be held by the shell, it is described that coarsely woven cotton cloth is to be used as said woven cloth. However, the woven cloth which is formed into a sleeve-like shape—as is clear from the fact that there is no description whatsoever in said Reference of this having stretchability—is ordinary woven cloth, from which it may be understood that the inside diameter of that sleeve made of woven cloth must be equal to—or to allow for insertion therewithin must be somewhat larger than—the outside diameter of the cylindrical hollow shell. In addition, the hollow shell constitutes a cylindrical hollow shell having a prescribed wall thickness. This being the case, when the open end portions of the sleeve made of woven cloth are folded back and tucked within the end portions of the shell, the difference in circumferential length between the shell inside diameter and the shell outside diameter will cause the sleeve made of woven cloth that has been folded back and tucked therewithin to form wrinkles at folds in the circumferential direction at the inner surface of the shell, as a result of which there will be overlap of the woven cloth. So long as this is in a state in which wrinkles are formed due to such wrinkles at folds, it will be difficult to even insert the end caps to the extent that these have any rigidity. In this regard, while it would at least be possible, by using caps comprising resin or the like and having elasticity as end caps, to press-fit the caps and secure the sleeve made of woven cloth, because press-fitting of the caps would be such that there would be locations at which woven cloth portions formed a single layer and there would be occurrence of portions at which wrinkles at folds caused formation of three layers of cloth, this would result in a state in which the center portions of the caps and the center portion of the cylindrical hollow shell were misaligned. As a result, there is need for an additional separate member that will support the shaft, being a member such as will cause the center portion of the shaft and the center portion of the hollow shell to be at approximately the same location, and being a separate member for supporting the shaft at a location at which the woven cloth does not intervene toward the center in the axial direction at the hollow shell toward the exterior of the end portion of the sleeve made of woven cloth at which the sleeve made of woven cloth is folded back on itself.

Thus, at the covered roller supported by the cylindrical support member which is proposed in Patent Reference No. 5, there is existence of a difference in circumferential length between the inside circumferential length of the inside diameter and the outside circumferential length resulting from the outside diameter of the cylindrical support member, it being unavoidable that there will be a large difference in circumferential length if the wall thickness of the cylindrical support member is large. In addition, when the covering is folded back on itself inside the cylindrical support member, the difference in circumferential length will cause occurrence of kinks, and the covering will overlap itself at the inner surface. This being the case, because with a flange or journal serving as insertion member and having rigidity there will be overlap of the covering with itself, press-fitting such that the covering intervenes therebetween will not be possible. For this reason, there is disclosure of a method in which the covering is secured by means of a soft resinous cap, and there is moreover disclosure of a method in which this is used without causing the covering to be folded back on itself. However, as described above, the device proposed at Patent Reference No. 5 is such that, due to the fact that the constitution is complicated, it will cause increase in the manufacturing cost of the roller, and because it is not conducive to production in large quantities, improvement is sought with respect to these points as well.

Moreover, with respect to detection of lifespan of covered rollers, methods for detecting wear of coverings which are method in which sensors are employed to detect wear have been proposed at Patent Reference Nos. 6 and 7 and elsewhere. However, in each of these methods, employment of a sensor is required, which is a factor that causes increase in manufacturing cost when incorporated into the apparatus.

A problem to be solved by the present invention is therefore to achieve reduction in cost and improvement in productivity, and to provide a covered roller at which the covering is adequately secured, and to provide means such as will allow lifespan of a covered roller to be easily detected.

### Means for Solving Problem

In the context of a roller which is shaped so as to be circular or semicircular and which has a rotating shaft at the center of the circle and at which a covering covers a surface of a rotating body that rotates, a first means in accordance with the present invention for solving the foregoing problems is a covered roller which is covered with the covering and which is characterized in that said rotating body has a region at which an insertion member is inserted inside the rotating body that is covered with the covering such that the covering intervenes therebetween; the covering, a length of which is greater than a width of said rotating body in a width (axial) direction, covers said rotating body so as to cause there to be a region that is made to protrude from said rotating body, an end portion of the covering in the region which has been made to protrude from said rotating body being formed such that heat-shrinking in a radial direction of the covering due to application of heat or contraction of the covering which is stretchable in at least the radial direction causes an inside circumferential length of the end portion of the covering in the region which has been made to protrude from said rotating body to be less than or equal to an inside circumferential length of an inside diameter of the rotating body; and the roller is such that at least the rotating body, the covering, and the insertion member are made integral, the covering being held to the rotating body surface as a result of the insertion member having been inserted— such that the covering in the protruding portion which has been folded back inside said rotating body intervenes therebetween—under at least press-fit conditions into the region at which the insertion member is inserted inside said rotating body such that the covering intervenes therebetween.

In the context of a roller which is shaped so as to be circular or semicircular and which has a rotating shaft at the center of the circle and at which a covering covers a surface of a rotating body that rotates, to cause retention of the intimate contact of a covering at a covered roller which is covered with the covering, a rotating body covered with a covering is made to have a region at which an insertion member is inserted inside the rotating body such that the covering intervenes therebetween, a length of the covering is made to be greater than a width in a width (axial) direction of the rotating body that is covered with the covering, the covering being made to protrude beyond the rotating body, heat-shrinking in the radial direction of the covering due to application of heat, or contraction of the covering where the rotating body is covered with a covering that has stretchability in at least the radial direction and that has been made to be longer than the width of the rotating body that is covered with the covering so as to protrude beyond the rotating body, causing an inside circumferential length of an end portion of the covering in the region which has been made to protrude from the rotating body to be less than or equal to an inside circumferential length of an inside diameter of the rotating body, the protruding portion of the covering being folded back inside the rotating body, the insertion member being inserted inside the rotating body under at least press-fit conditions such that the covering intervenes therebetween, and the covering being held to the rotating body surface, as a result of which the roller is made to be such that at least the rotating body, the covering, and the insertion member are made integral.

In the context of a roller which is shaped so as to be circular or semicircular and which has a rotating shaft at the center of the circle and at which a covering covers a surface of a rotating body that rotates, a second means in accordance with the present invention for solving the foregoing problems is a covered roller which is covered with the covering and which is characterized in that the roller is such that the rotating body is covered by the covering which is woven/knit fabric comprising knit fabric or woven fabric that is cylindrical and that has stretchability in at least a radial direction or woven/knit fabric that undergoes heat-shrinking in the radial direction and which is formed so as to be cylindrical; said rotating body has a region at which an insertion member is inserted inside the rotating body that is covered with said covering such that said covering intervenes therebetween; the covering which is said woven/knit fabric comprising knit fabric or woven fabric which is cylindrical covers said rotating body so as to protrude from said rotating body at which insertion takes place, said covering being formed so as to have a circumferential length such as will cause intimate contact of the woven/knit fabric with an inner surface and an outside circumferential surface of the rotating body when the cylindrical woven/knit fabric is made to undergo heat-shrinking due to application of heat, or being formed so as to cause an inside circumferential length of an end portion of the cylindrical woven/knit fabric in a region which protrudes from the rotating body to be less than or equal to an inside circumferential length of an inside diameter of the rotating body as a result of contraction of the woven/knit fabric when stretchability of the cylindrical woven/knit fabric causes the cylindrical woven/knit fabric to be intimate contact with the rotating body surface; and the roller is such that at least the rotating body, the covering, and the insertion member have been made to be integral, the covering being held to the rotating body surface as a result of the insertion member having been inserted under at least press-fit conditions inside the rotating body such that the covering in the protruding portion which has been folded back inside the rotating body intervenes therebetween.

In the context of a roller which is shaped so as to be circular or semicircular and which has a rotating shaft at the center of the circle and at which a covering covers a surface of a rotating body that rotates, to cause retention of the intimate contact of a covering at a covered roller which is covered with the covering, the rotating body which is covered with the covering is made to have a region at which an insertion member is inserted inside the rotating body such that the covering intervenes therebetween; the roller is covered by the covering which is such that the covering is woven/knit fabric comprising knit fabric or woven fabric; the covering is woven/knit fabric that is cylindrical and that has stretchability in at least a radial direction or woven/knit fabric that undergoes heat-shrinking in the radial direction and which is formed so as to be cylindrical; the constitution being such that the rotating body is inserted within this cylindrical covering such that the covering protrudes from the rotating body and is formed so as to have a circumferential length such as will cause intimate contact of the woven/knit fabric with an inner surface and an outside circumferential surface of the rotating body when the cylindrical woven/knit fabric is made to undergo heat-shrinking due to application of heat, or is formed so as to cause an inside circumferential length of an end portion of the covering in a region which protrudes from the rotating body to be less than or equal to an inside circumferential length of an inside diameter of the rotating body as a result of contraction of the woven/knit fabric when stretchability of the cylindrical woven/knit fabric causes it to be intimate contact with the rotating body surface; and the roller is such that at least the rotating body, the covering, and the insertion member are made integral due to the fact that the covering is held to the rotating body surface as a result of the fact that, after the protruding covering is folded back inside the rotating body, the insertion member is inserted under at least press-fit conditions inside the rotating body such that the covering intervenes therebetween.

In the context of a roller which is shaped so as to be circular or semicircular and which has a rotating shaft at the center of the circle and at which a covering covers a surface of a rotating body that rotates, a third means in accordance with the present invention for solving the foregoing problems is a covered roller which is covered with the covering and which is characterized in that the roller is such that the rotating body is covered by the covering, the covering being woven/knit fabric comprising knit fabric or woven fabric; said rotating body has a region at which an insertion member is inserted inside the rotating body that is covered with said covering such that said covering intervenes therebetween; said covering is formed so as to be cylindrical, the covering being formed from woven/knit fabric having stretchability in at least a radial direction, and being formed so that— before being inserted into the rotating body—an inside circumferential length of the cylindrical covering is less than or equal to an inside circumferential length of an inside diameter of the rotating body in the region at which the insertion member is inserted in the rotating body such that the covering intervenes therebetween; and the cylindrical covering which has said stretchability covers said rotating body so as to protrude from said rotating body at which insertion takes place, a protruding site of said covering being folded back inside the rotating body, insertion by the insertion member inside the rotating body such that said covering intervenes therebetween being moreover carried out under at least press-fit conditions, said covering being held to the rotating body surface, the roller being such that at least the rotating body, the covering, and the insertion member have been made integral.

In the context of a roller which is shaped so as to be circular or semicircular and which has a rotating shaft at the center of the circle and at which a covering covers a surface of a rotating body that rotates, to cause retention of the intimate contact of a covering at a covered roller which is covered with the covering, the rotating body which is covered with the covering is made to have a region at which an insertion member is inserted inside the rotating body such that the covering intervenes therebetween; the roller is covered by the covering which is such that the covering is woven/knit fabric comprising knit fabric or woven fabric; the covering is formed so as to be cylindrical, the covering being formed from woven/knit fabric having stretchability in at least a radial direction, and being formed so that—before being inserted into the rotating body—an inside circumferential length of the cylindrical covering is less than or equal to an inside circumferential length of an inside diameter of the rotating body in the region at which the insertion member is inserted in the rotating body such that the covering intervenes therebetween; and the rotating body is inserted into the cylindrical covering which has this stretchability, the constitution being such that the stretchable cylindrical woven/knit fabric protrudes beyond the width of the rotating body, the covering that had been made to protrude being folded back inside the rotating body, the insertion member being inserted inside the rotating body under at least press-fit conditions such that said covering intervenes therebetween, and the covering being held to the rotating body surface, as a result of which the roller is made to be such that at least the rotating body, the covering, and the insertion member are made integral.

In the context of a rotating body which is shaped so as to be circular or semicircular and which has a rotating shaft at the center of the circle and at which a covering comprising woven/knit fabric covers a surface of the rotating body that rotates, a fourth means in accordance with the present invention for solving the foregoing problems is a covered roller which is covered with the covering and which is characterized in that the covering is woven/knit fabric that is formed so as to be cylindrical, and is cylindrical woven/knit fabric that is formed from monofilament yarn or multi-monofilament yam, and is cylindrical woven/knit fabric that has stretchability in at least a radial direction; and said cylindrical covering covers the rotating body such that an end portion of the covering protrudes beyond the width of the rotating body, and is furthermore formed such that contraction pursuant to stretchability of said cylindrical covering causes an outside circumferential length of the end portion of the covering in a region which protrudes from the rotating body to be less than or equal to an inside circumferential length of an inside diameter of the rotating body in a region at which an insertion member is inserted in the rotating body, the covering in said protruding region is folded back inside the rotating body, and insertion by the insertion member in the rotating body such that the covering intervenes therebetween is furthermore carried out under at least press-fit conditions, such that said covering is held to the rotating body surface, and the roller is such that at least the rotating body, the covering, and the insertion member are made integral.

In the context of a rotating body which is shaped so as to be circular or semicircular and which has a rotating shaft at the center of the circle and at which a covering comprising woven/knit fabric covers a surface of the rotating body that rotates, to cause retention of the intimate contact of a covering at a covered roller which is covered with the covering, the covering is woven/knit fabric that is formed so as to be cylindrical, and is cylindrical woven/knit fabric that is formed from monofilament yarn or multi-monofilament yarn, and is cylindrical woven/knit fabric that has stretchability in at least a radial direction; and this cylindrical covering is made to cover the rotating body, covering thereof being such that it protrudes beyond the width of the rotating body, and is formed such that contraction pursuant to stretchability of the cylindrical covering causes an outside circumferential length of the end portion of the covering in a region which protrudes from the rotating body to be less than or equal to an inside circumferential length of an inside diameter of the rotating body in a region at which an insertion member is inserted in the rotating body, the protruding covering is folded back inside the rotating body, and the insertion member is inserted in the rotating body under at least press-fit conditions such that the covering intervenes therebetween, such that said covering is held to the rotating body surface, as a result of which the roller is made to be such that at least the rotating body, the covering, and the insertion member are made integral.

A fifth means in accordance with the present invention for solving the foregoing problems is the covered roller which is covered with the covering according to any one of the first means through the fourth means in accordance with the present invention characterized in that, in the context of the rotating body which is shaped so as to be circular or semicircular and which has the rotating shaft at the center of the circle and at which the covering comprising woven/knit fabric covers the surface of the rotating body that rotates, the insertion member which is inserted under at least press-fit conditions into the rotating body such that the covering intervenes therebetween is a flange-shaped insertion member.

In the context of the rotating body which is shaped so as to be circular or semicircular and which has the rotating shaft at the center of the circle and at which the covering comprising woven/knit fabric covers the surface of the rotating body that rotates, to cause retention of the intimate contact of a covering at a covered roller which is covered with the covering, a flange-shaped insertion member is employed as the insertion member which is inserted under at least press-fit conditions into the rotating body such that the covering intervenes therebetween.

A sixth means in accordance with the present invention for solving the foregoing problems is a covering intimate contact retention method and the covered roller which is covered with the covering according to the fifth means in accordance with the present invention characterized in that the insertion member which is flange-shaped at the end portion of the rotating body is formed such that an outside diameter at a flange portion of the insertion member is less than an outside diameter of the rotating body which is covered with the covering.

To cause retention of the intimate contact of a covering at a covered roller which is covered with the covering, an item which is formed such that an outside diameter at a flange portion of the insertion member is less than an outside diameter of the rotating body which is covered with the covering is employed as the insertion member which is flange-shaped at the end portion of the rotating body.

A seventh means in accordance with the present invention for solving the foregoing problems is a covering retention method and the roller which is covered with the covering according to the sixth means in accordance with the present invention characterized in that the insertion member which is flange-shaped at the end portion of the rotating body is such that the outside diameter at the flange portion of the insertion member is less than the outside diameter of the rotating body which is covered with the covering, and the outside diameter at the flange portion of the insertion member is equal to the outside diameter of the rotating body before being covered or the outside diameter at the flange portion is greater than the outside diameter of the rotating body before being covered.

To cause retention of the intimate contact of a covering at a covered roller which is covered with the covering, an item which is such that the outside diameter at the flange portion of the insertion member is less than the outside diameter of the rotating body which is covered with the covering, and the outside diameter at the flange portion of the insertion member is equal to the outside diameter of the rotating body before being covered or the outside diameter at the flange portion is greater than the outside diameter of the rotating body before being covered, is employed as the insertion member which is flange-shaped at the end portion of the rotating body.

An eighth means in accordance with the present invention for solving the foregoing problems is a method for detecting a lifespan of the covered roller which is covered with the covering according to any one of claim 1 through claim 7 characterized in that the covered roller which is covered with the covering according to any one of the first means through the seventh means in accordance with the present invention is used, the insertion member which is flange-shaped at the end portion of the rotating body of said covered roller is formed from a material comprising an electrically conductive member, the rotating body is covered with a cylindrical woven/knit fabric comprising insulating characteristics, an outside diameter at a flange portion of the insertion member which is flange-shaped is less than an outside diameter of the covered rotating body, the outside diameter at the flange portion of the insertion member is greater than the outside diameter of the rotating body before being covered, an electrically conductive member which is independent of said flange is arranged at a location which is opposed to said flange and the rotating body which is covered with the insulating covering and which has the flange of the insertion member which is formed from the material comprising said electrically conductive member, lifespan of the rotating body due to wear of the covering of the covered rotating body is detected as lifespan of the covered roller which is covered with the insulating covering upon detection of an electrical signal pertaining to electrical continuity occurring due to contact between the flange of the insertion member which is formed from the material comprising said electrically conductive member and the electrically conductive member which is independent of said flange which is arranged at the location which is opposed to the flange of the insertion member which is formed from the material comprising said electrically conductive member.

Another means in accordance with the present invention for solving the foregoing problems is a method for detecting and detection of a lifespan of a rotating body which is covered with a covering characterized in that the insertion member which is flange-shaped at the end portion of the rotating body is formed from a material comprising an electrically conductive member, the rotating body is covered with a cylindrical woven/knit fabric comprising insulating characteristics, an outside diameter at a flange portion of the insertion member which is flange-shaped is less than an outside diameter of the covered rotating body, the outside diameter at the flange portion of the insertion member is greater than the outside diameter of the rotating body before being covered, a member having electrical conductivity is arranged at a location which is opposed to this electrically conductive flange and the rotating body which is covered with the insulating covering and which has this electrically conductive flange, lifespan of the rotating body due to wear of the covering of the covered rotating body is detected, lifespan of the rotating body which is covered with the insulating covering being detected, upon detection of an electrical signal pertaining to electrical continuity resulting from contact between the electrically conductive member which is opposed to this electrically conductive flange.

### Benefit of Invention

As a result of employment of means in accordance with the present invention, simple fabrication of a covered roller is made possible, and it also possible to cause the center of a rotating body to have approximately the same center as the center of a shaft, making it possible to fabricate a covered roller of good precision which was not available conventionally. In addition, as a result of employment of means in accordance with the present invention, it will be possible to fabricate a low-cost covered roller because it will be possible to easily produce the covered roller, and conservation of resources will moreover be made possible because it will be possible to easily replace the covering when the covering of the covered roller has worn and lifespan of the covering has been reached.

Furthermore, when employing means in accordance with the present invention, employment of a cylindrical covering constituted from monofilament, for example, will make it possible to cause coarse mesh openings and steps to be easily constituted by means of monofilament, and will permit achievement of a roller which is robust with respect to contamination and clogging of mesh openings. Furthermore, when employing means in accordance with the present invention, by causing this to be covered with a covering having coarse mesh openings, it will be possible to easily fabricate a roller having air permeability. Moreover, when employing means in accordance with the present invention, by employing a yarn in which urethane or other such rubber elastic fiber covers a core yarn, it will be possible to easily fabricate a roller having a large force of friction at the surface thereof. And where a covering that employs multifilament is employed, it will be possible to easily form a roller having fine mesh openings. Moreover, by employing a cylindrical covering employing spun yarn comprising discontinuous fibers, it will be possible to easily fabricate a roller having a soft surface. In addition, by varying the material of the covering, it will be possible in accordance with the means of the present invention to easily fabricate covered rollers having varied and diverse properties, such as a roller having a low coefficient of friction at the surface thereof where fluoro-type fiber is employed, a heat-resistant covered roller where heat-resistant fiber is employed, a covered roller having high endurance for industrial use where a covering comprising electrical wire from metal fiber is employed, and so forth. Thus, employment of means in accordance with the present invention will make it possible to provide covered rollers capable of being supplied to a variety of industrial fields.

### BRIEF DESCRIPTION OF DRAWINGS

FIG. 1 shows an exemplary diagram of the constitution of a covered roller that does not have a flange (collar) in accordance with a means of the present invention.

FIG. 2 shows an exemplary diagram of the constitution of a covered roller in which the covering is constituted by a cylindrical knit and which has a flange (collar) in accordance with a means of the present invention.

FIG. 3 shows an exemplary diagram of the constitution of a covered roller in which the covering is constituted by a cylindrical weave and which has a flange (collar) in accordance with a means of the present invention.

FIG. 4 shows an exemplary constitution of a cylindrical rotating body for causing covering by a covering.

FIG. 5 shows an exemplary constitution of a cylindrical rotating body for causing covering by a covering.

FIG. 6 shows an exemplary cylindrical rotating body which is covered by a covering, wherein a cylindrical covering is made to cover a rotating body in such state that the two end portions thereof protrude beyond the two ends of the rotating body.

FIG. 7 shows an exemplary method in which a cylindrical woven fabric employing heat-shrink yarn at weft yarn is used, said cylindrical woven fabric being made to cover a rotating body and achieve support thereof.

FIG. 8 shows an exemplary method and conditions under which a cylindrical woven fabric employing stretch fiber at weft yarn might be used, said cylindrical woven fabric being made to cover a rotating body.

FIG. 9 shows an exemplary method and conditions under which a cylindrical knit fabric comprising warp-knit fabric might be used, said cylindrical knit fabric being made to cover a rotating body.

FIG. 10 shows an exemplary constitution in which a covering is folded back upon itself inside a rotating body, press-fitting thereof being thereafter achieved by means of an insertion member having a flange (collar).

FIG. 11 shows a method for measuring a covering with which a rotating body is covered.

FIG. 12 shows an exemplary constitution of a method for detecting lifespan due to wear at the present covered roller having a flange (collar).

FIG. 13 shows a graph of a relationship between covering contact load and covering thickness.

### EMBODIMENTS FOR CARRYING OUT INVENTION

Below, embodiments for carrying out means in accordance with the present invention are described with reference to the drawings.

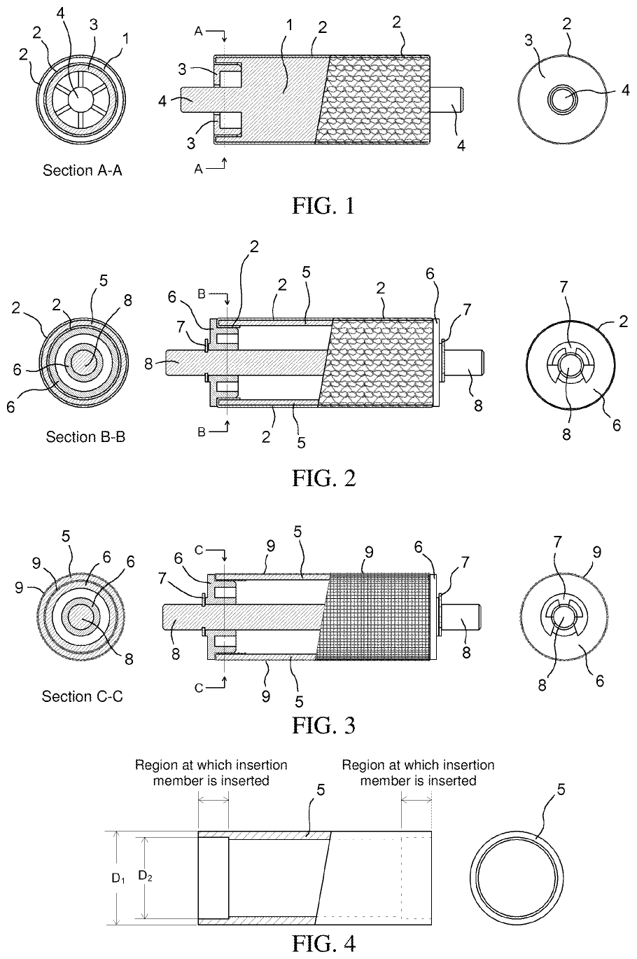

FIG. 1, FIG. 2, and FIG. 3 show examples of covered rollers at means in accordance with the present invention, in which a rotating body 1, 5 is covered with a covering 2, 9, the covering 2, 9 being secured such that covering 2, 9 intervenes therebetween by insertion members 3, 6 which are inserted in the rotating body end portions.

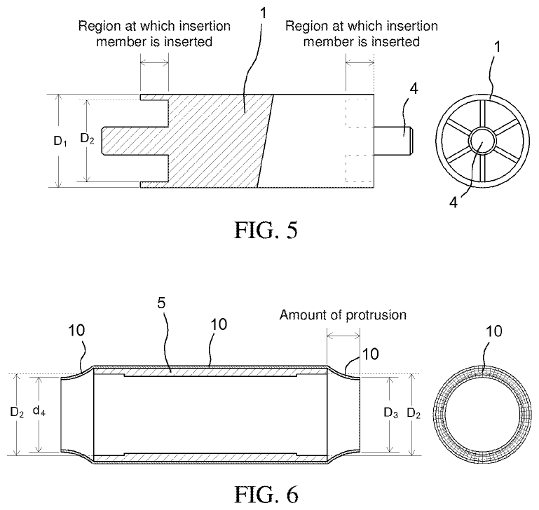

FIG. 4 and FIG. 5 show examples of the structure of the rotating body 1, 5 before it is covered by the covering. The rotating body outside diameter is taken to be D₁, and a region being present at which the insertion member is inserted such that the covering intervenes therebetween, the rotating body inside diameter at the portion where the insertion member is inserted such that the covering intervenes therebetween is taken to be D₂ (see FIG. 4 and FIG. 5). FIG. 4 shows an example of a rotating body 5 which is a cylindrical body (i.e., it does not have a shaft); FIG. 5 shows an example of a rotating body 1 having a structure which is such that it has a shaft. These rotating bodies might be constituted from metal and/or resin.

FIG. 6 shows a situation in which rotating body 5 is provided with stretchable cylindrical covering 10, and in which said covering 10 has been made to protrude from the two ends of the rotating body, an example being shown in which the constitution is such that inside diameter d₄ at the end portion of covering 10 is less than the inside diameter at the insertion portion of the rotating body. The reason for this is that by causing the constitution to be such that the inside circumferential length 14 of end portion d₄ of covering 10 is less than or equal to the inside circumferential length L2 of rotating body inside diameter D₂, a condition will be achieved by which the relationship of the inside circumferential length is such that L2≥14, which constitutes a condition for preventing overlap of the cylindrical covering 10 with itself at the inside of rotating body 5 when the cylindrical covering 10 that had been made to protrude therefrom is folded back inside rotating body 5.

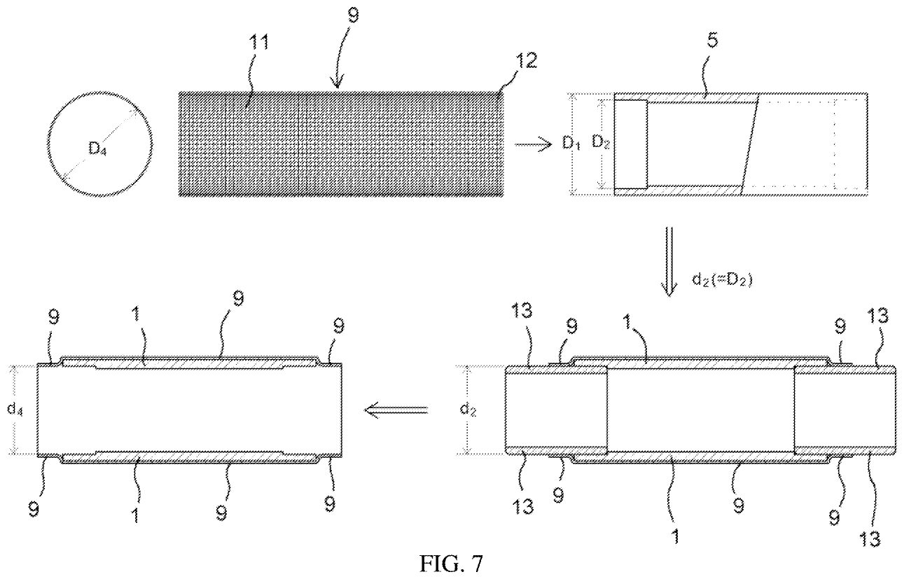

In addition, as means for causing the inside circumferential length 14 of inside diameter d₄ at the end portion of the covering that had been made to protrude from the rotating body to be formed such that it is less than or equal to the inside circumferential length L2 of rotating body inside diameter D₂, the means in the example of FIG. 7 in which covering 9 is a woven fabric comprising cylindrical weave at which the yarn (weft yarn 11) used in the rotational direction employs heat-shrink yarn is constituted in advance such that inside circumferential length L4 of cylindrical woven fabric inside diameter D₄ is greater than outside circumferential length L1 of rotating body outside diameter D₁, so that when rotating body 5 is inserted within cylindrical woven fabric 9 constituting the covering, cylindrical woven fabric 9 is made to protrude from rotating body 5, the constitution being such that when jig 13 having diameter d₂, which is approximately equal to inside diameter D₂ of rotating body 5, is inserted within the inside diameter of the rotating body, the covering that is made to protrude therefrom is made to cover the surface of this jig 13. An example is indicated in which heating is thereafter carried out, cylindrical covering 9 being made to undergo heat-shrinking so as to cause the inside circumferential length L4 of covering 9 before being heated to be made to be 14 following heating, and after heat-shrinking has been carried out so as to cause the length thereof to be approximately equal to that of inside circumferential length L2 of inside diameter D₂ of rotating body 5, jig 13 is removed therefrom, and covering 9 is folded back inside the rotating body so as to cause the inner surface of covering 9 to be in intimate contact with rotating body inside diameter Dz. As a result of adoption of such constitution, by causing inside circumferential length L2 of rotating body inside diameter D₂ and inside circumferential length 14 following heating of covering 9 which had been made to protrude from rotating body 5 to be approximately equal, this example makes it possible to achieve a condition such that overlap does not occur when covering 9 is folded back upon itself.

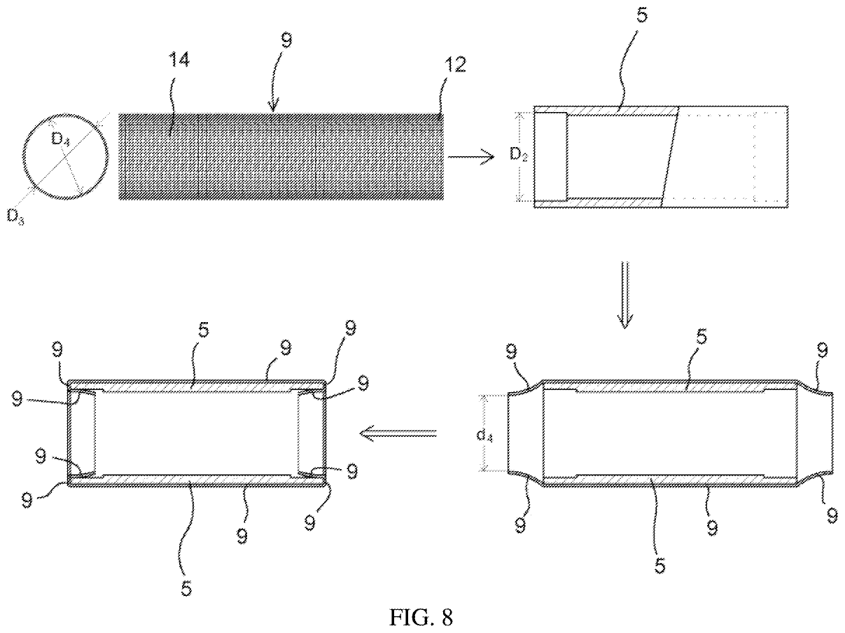

Furthermore, at the example of FIG. 8, in which cylindrical woven fabric 9 is constituted such that stretchable yarn is employed at weft yarn 14 so as to permit stretching in the radial direction, this is constituted in advance such that inside circumferential length L4 of the stretchable cylindrical woven fabric covering— before being used to cover anything—is less than inside circumferential length L2 of rotating body inside diameter D₂, the constitution being such that the covering protrudes from rotating body 5 when the covering covers rotating body 5, the amount by which the covering protrudes therefrom being constituted so as to cause inside circumferential length 14 at the end portion of the protruding covering to be less than or equal to inside circumferential length L2 of rotating body inside diameter D₂ due to the force of contraction from the stretch fibers, an example being indicated in which this is in a state in which it is folded back inside rotating body 5. As a result of adoption of such constitution, relative to inside circumferential length L2 at the portion of inside diameter D₂ at rotating body 5, inside circumferential length 14 of cylindrical covering 9 makes it is possible to achieve a condition such that overlap of covering 9 does not occur within the region of D₂ when this is folded back upon itself.

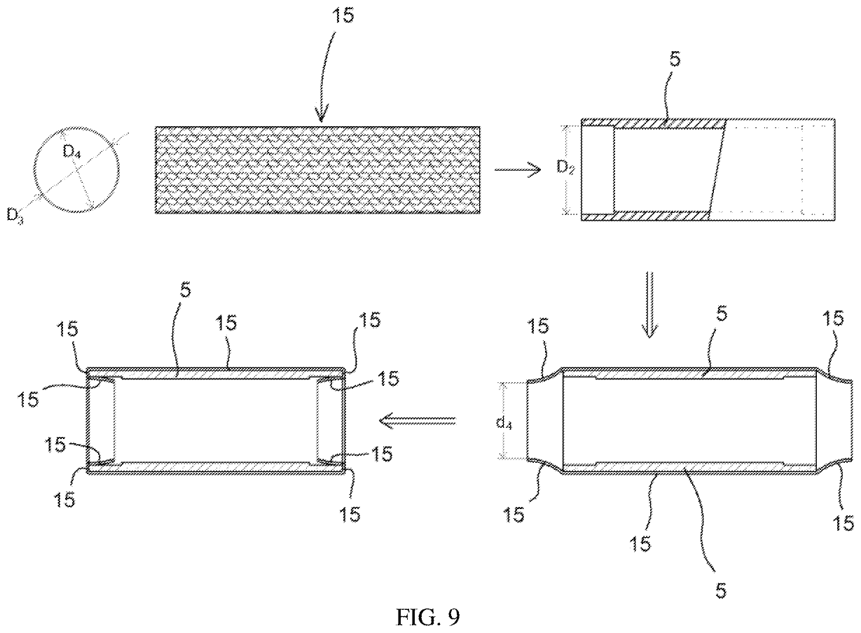

Moreover, FIG. 9 shows an example of a situation in which covering is achieved by a covering 15 made up of a cylindrical knit. Because as is characteristic of knits this is stretchable, this is constituted in advance such that inside circumferential length L4 of the cylindrical knit—before being used to cover anything—is less than inside circumferential length L2 of rotating body inside diameter D₂, the constitution being such that covering 15 protrudes from rotating body 5 when covering 15 is made to cover rotating body 5, the amount by which covering 15 protrudes therefrom being constituted so as to cause inside circumferential length 14 at the end portion of protruding covering 15 to be less than or equal to the inside circumferential length of rotating body inside diameter D₂ due to the force of contraction from the stretch fibers, an example being indicated in which this is in a state in which there is no overlap of covering 15 when this is folded back inside rotating body 5.

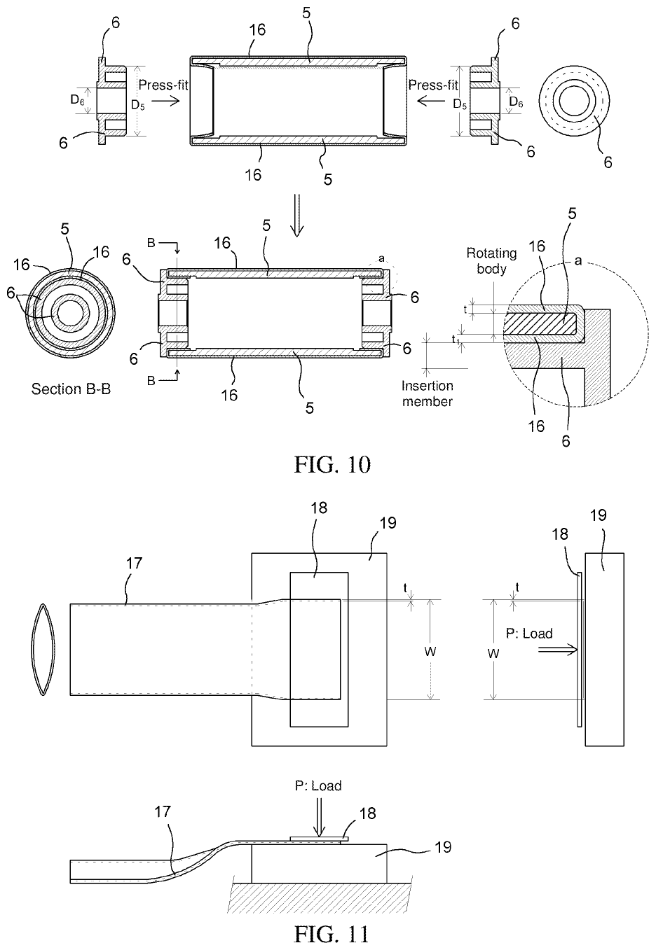

In addition, FIG. 10 shows an example in which, after achieving a condition such that overlap of covering 16 does not occur when cylindrical covering 16 is folded back at the rotating body inner surface pursuant to the examples of FIG. 7, FIG. 8, and FIG. 9, insertion member 6 is inserted within an insertion region at the inner surface of rotating body 5 such that covering 16 intervenes therebetween.

Covering 16 is constituted such that inside circumferential length 14 at the end portion of covering 16 is less than or equal to inside circumferential length L2 of the rotating body inner surface, press-fitting of insertion member 6 causing insertion to be such that there is intimate contact with or expansion of covering 16, and causing a state to be achieved in which there is no overlap of covering 16 at the rotating body inner surface. This will also make it possible to fabricate this such that runout precision of the roller surface relative to the shaft center is good. Moreover, because insertion member 6 is press-fit thereinto such that covering 16 intervenes therebetween, this makes it possible to achieve a state in which covering 16 is in intimate contact with the surface, as it is pulled in the axial direction so that there is no slack at the rotating body surface. In addition, this makes it possible to form a covered roller without the need for the pressure-sensitive adhesive and/or non-pressure-sensitive adhesive that were required conventionally. Furthermore, regarding press-fitting conditions, which are determined by inside diameter D₂ of rotating body 5, thickness t of covering 16, and outside diameter D₅ of insertion member 6, conditions should be set so that there is no freewheeling between rotating body 5 and insertion member 6. Moreover, where an insertion member 6 having a flange (collar) is employed, because covering 16 will also be pressed on by the flange (collar), this will make it possible to achieve a constitution in which covering 16 is even less likely to become dislocated. Moreover, to reduce dislocation of covering 16, it is preferred that the surface be made rough by imparting roughness thereto in the form of a bumpy pattern when the surface of the uncovered rotating body is molded resin, subjecting this to shot/sand blasting or hairline treatment when the rotating body is metal, and/or the like.

In addition, where necessary, adhesive may be used to secure rotating body 5, covering 16, and/or insertion member 6.

As material from which cylindrical covering 16 may be constituted, this may be constituted from spun yarn comprising spun discontinuous fibers, multifilament yarn comprising continuous fibers, and/or yarn comprising monofilament. In addition, such yarn(s) may be selected in correspondence to the functionalities that may be required. Furthermore, regarding press-fitting conditions as well, press-fitting conditions may be established based upon consideration of the change in thickness that will occur when compressed depending on the yarn(s) from which it is constituted.

Because a roller that is covered with cylindrical woven/knit fabric employing spun yarn will possess the surface softness that is characteristic of spun yarn, this is suitable for fabrication of rollers requiring a soft touch and so forth; because a covered roller employing multifilament will be such that the filament will be densely packed and because the filament material will comprise synthetic fibers, this will permit fabrication of rollers having varied and diverse functionalities. For example, with cylindrical woven/knit fabric employing fluorinated fiber, it will be possible to fabricate a roller having a reduced coefficient of friction at the surface; or if fabricated using yarn which includes elastic fiber, this will make it possible to fabricate a roller having a high coefficient of friction. Moreover, where priority is given to cost, use of a roller employing Nylon multifilament yarn will make it possible to fabricate a roller having good wear resistance; or where polyester-fiber multifilament yarn is employed, this will make it possible to fabricate a roller which is strong with respect to environmental resistance, and will make it possible to fabricate a roller permitting reduction in cost when used as a covered roller. Moreover, by using multifilament yarn, because it will be possible to cause mesh openings to be small such that there is little variation in thickness, this will make it possible to fabricate a roller of good precision.

With cylindrical woven/knit fabric employing monofilament, due to the fact that it will be possible to fabricate a roller having coarser mesh openings than would be the case with a covering that employed multifilament yarn, this will make it possible, at low cost, to fabricate a roller for which there is little clogging of mesh openings, or in the case of roller which employs ink, a roller for which there is little soiling. Furthermore, where urethane fiber constituting elastic fiber is used as covering for monofilament, this will make it possible to fabricate a roller having coarse mesh openings and a high coefficient of friction.

Thus, as a result of adoption of a constitution in which an end portion at a covered rotating body permits an insertion member to be press-fit thereinto such that the covering intervenes therebetween, it is possible to improve efficiency of operations, reduce parts count, and also fabricate a covered roller which was not available conventionally and which is a covered roller that employs molded part(s) comprising resin material(s). In addition, to fabricate a covered roller in accordance with the present invention, manufacturing method(s) and condition(s) are required so as to prevent overlap of the covering at the rotating body inner surface. For this reason, the covering must be designed and set so that the inside circumferential length and outside circumferential length of the cylindrical covering will conform to the inside diameter and outside diameter of the rotating body that will be covered thereby.

In addition, so as to be able to carry out fabrication of this cylindrical covering, method(s) such as will permit measurement or calculation of inside circumferential length, outside circumferential length, and thickness will be necessary.

FIG. 11 shows an example of a situation in which measurement is carried out in accordance with a method in which a cylindrical covering is used, width W of the cylindrical covering being measured when in a state such that the inner surface of the cylindrical covering has been made to abut itself and come into intimate contact with itself under a prescribed load, and in which width W is used to calculate inside circumferential length, with calculation of inside diameter and also outside diameter being such that that these are calculated from the inside circumferential length and the cylindrical woven fabric thickness.

Moreover, although not shown in the drawings, a thickness gauge—e.g., a PG-11 Constant-Pressure Thickness Gauge manufactured by Teclock, a Model-G manufactured by Peacock, or the like—would first be used to measure thickness t of the cylindrical woven fabric. In addition, as shown in FIG. 11, width W of cylindrical covering 17 is measured while cylindrical covering 17 which is cylindrical woven fabric is squashed above measurement stage 19 by glass plate 18 or the like under a prescribed load, causing it to abut itself such that the inner surface of cylindrical covering 17 is in a state such that it is in intimate contact with itself. Regarding the measurement load at this time, to cause the inner surface of cylindrical covering 17 to be in a state such that it is in intimate contact with itself, a load such as will cause this to be on the order of approximately two times the thickness t measured above is applied thereto, a scale, calipers, optical gauge, or other such measuring device being used to measure width W. In addition, inside circumferential length L4 of cylindrical covering 17 is calculated from thickness t of cylindrical covering 17 and width W of cylindrical covering 17. As shown in FIG. 11, inside circumferential length L4 of cylindrical covering 17 may be calculated from thickness t and width W of cylindrical covering 17 as (W−2t)×2. By calculating inside circumferential length L4 from the measured value and the calculated value, the inside diameter of cylindrical covering 17 can be found to be L4/π=D₄. Furthermore, outside diameter D₃ of cylindrical covering 17 may be calculated as D₄+2t, and multiplying this by π will make it possible to calculate outside circumferential length L3.

By carrying out calculation in this way, because the outside circumferential length and outside diameter of the rotating body to be covered and the inside circumferential length and inside diameter of the rotating body are known, it will be possible to establish the thickness and inside circumferential length of the required covering.

As a constitution of the present invention, the constitution may be such that a covering is made to cover a rotating body so as to protrude from the rotating body, the constitution being such that a relationship between inside circumferential length L2 of rotating body inside diameter D₂ within a region at which an insertion member is inserted into the rotating body and inside circumferential length 14 at the end portion of the covering that had been made to protrude from the rotating body is such that L2≥14, and the constitution being such that there is no overlap of the covering at the inner surface of the rotating body when the covering that had been made to protrude is folded back at the inner surface of the rotating body. For this reason, as condition(s) for causing the rotating body to be covered, where the rotating body is to be covered with a heat-shrink cylindrical covering, condition(s) before being heated should be such that outside circumferential length L1 of rotating body outside diameter D₁<inside circumferential length L4 of the covering before being heated, it being a necessary condition that the inside circumferential length be such that following heating inside circumferential length 14 at the end portion of the covering that had been made to protrude be equivalent to or somewhat less than inside circumferential length L2 of rotating body inside diameter Dz. Furthermore, where a cylindrical covering that is stretchable in the radial direction is used, by constituting this such that the relationship inside circumferential length L2 of rotating body inside diameter D₂≥inside circumferential length L4 of the covering—before being used to cover anything—is satisfied, a condition will be achieved by which there is no overlap of the covering when the covering is folded back at the inside surface of the rotating body. In addition, this will make it possible to achieve a state such that the covering is in intimate contact with the inner surface of the rotating body and there is no overlap of the covering with itself even though the covering is folded back inside the rotating body and an insertion member is press-fit thereinto such that the covering intervenes therebetween, and will make it possible to easily fabricate a covered roller having little runout relative to the axis. Adoption of such constitution will make it possible to provide a covered roller which is of low cost and which permits reduction in manufacturing cost which was not available conventionally.

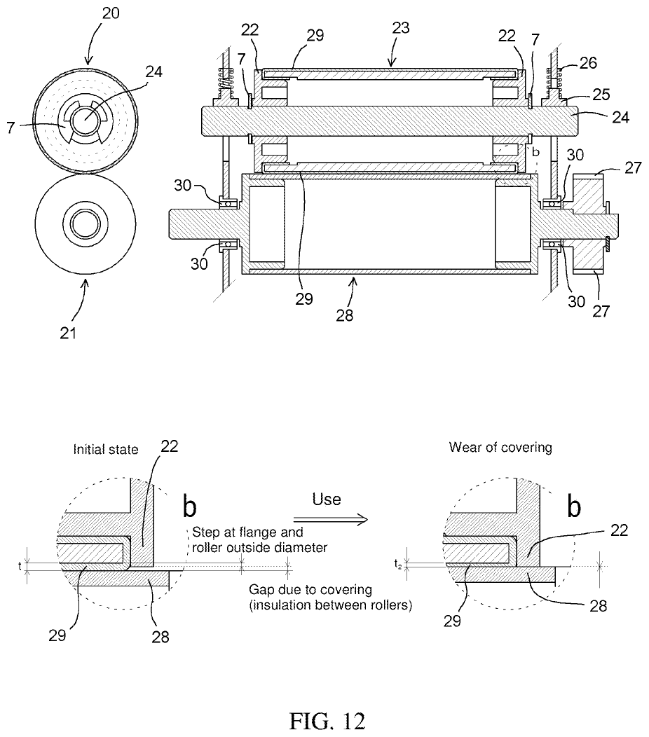

Furthermore, by using an insertion member having a flange (collar) which is used in accordance with the present invention, it is possible to detect roller lifespan due to wear of the covering when used over a long period of time. An example of the mechanism in accordance with such means is shown in FIG. 12. The example of FIG. 12 is an example in which covered roller 23 which is an idler roller is provided in such fashion as to oppose electrically conductive drive roller 28 which might for example be a metal roller, rotation of electrically conductive drive roller 28 which is opposed to this covered roller causing covered roller 23 which is an idler roller to rotate in idler fashion. This is a typical mechanism for transport of objects by the nip formed between a pair of rollers, being a mechanism for transport of thin objects, e.g., resin sheets, paper, and so forth. In addition, it is normally the case that wear of covering 29 will occur due to slight differences in speed, the lifespan of the roller being determined by such wear, it also sometimes being the case that wear of covering 29 will cause damage to the apparatus. For this reason, it is sometimes the case that testing is carried out in advance and the number of rotations for which there will be no damage to the apparatus is determined, the lifespan of the apparatus or the like being taken to be that number of rotations. To prevent such a situation, as shown in the example of FIG. 12, at covered roller 23, the insertion member is electrically conductive flange 21, covering 29 intervening therebetween, the outside diameter of this electrically conductive flange 21 being formed so as to be larger than the outside diameter of the rotating body before being covered, and being constituted so as to be smaller than the outside diameter of the rotating body after it has been covered, with covering 29 being constituted from insulating material. By so doing, an insulating state is achieved between the rollers.

In addition, when a prescribed amount of wear is reached at covering 29, the fact that this electrically conductive flange 22 makes contact with drive roller (electrically conductive roller) 28 causes there to be electrical continuity between the rollers, detection of which makes it possible to detect roller lifespan, and makes it possible to prevent damage to the apparatus. With respect to detection means, there are a variety of methods therefor, detection by means of electric current, or by means of reduction in voltage or other such electrical detection permitting detection of lifespan of a covered roller to be such that detection is achieved at low cost such as was not available conventionally.

### Working Examples

Listed at TABLE 1 are several Working Examples employing means in accordance with the present invention and Comparative Examples employing conventional methods.

TABLE 1

| | Working | Working | Working | Working | Working | Working | | |
|---|---|---|---|---|---|---|---|---|
| Cylindrical | Example | Example | Example | Example | Example | Example | Comparative | Comparative |
| Woven/Knit Fabric | 1 | 2 | 3 | 4 | 5 | 6 | Example 1 | Example 2 |
| Woven/Knit Fabric | Cylindrical | Cylindrical | Cylindrical | Cylindrical | Cylindrical | Cylindrical | Cylindrical | Cylindrical |
| | warp-knit | warp-knit | warp-knit | warp-knit | warp-knit | warp-knit | warp-knit | warp-knit |
| | | | | | | | | (using covering |
| | | | | | | | | from Working |
| | | | | | | | | Example 6) |
| Yarn | Mono- | Mono- | Double | Double | Covering yarn | Multi- | Monofilament | Multi- |
| | filament | filament | mono- | mono- | elastic fiber | filament | Same yarn as yarn | filament |
| | | | filament | filament | (urethane fiber) | | at Working | |
| | | | | | | | Example 1 | |
| Cylindrical knit | 0.48 | 0.54 | 0.66 | 0.76 | 0.65 | 0.49 | 0.48 | 0.49 |
| fabric thickness: t | | | | | | | | |
| (mm) | | | | | | | | |
| Width when in | 27.80 | 26.20 | 27.80 | 28.00 | 20.80 | 28.00 | 30.50 | 28.00 |
| intimate contact: W | | | | | | | | |
| (mm) | | | | | | | | |
| Inside | 53.68 | 50.24 | 52.96 | 52.96 | 39.00 | 54.04 | 59.08 | 54.04 |
| circumferential | | | | | | | | |
| length of covering | | | | | | | | |
| portion: L₄ (mm) | | | | | | | | |
| Inside diameter: D₄ | 17.09 | 15.99 | 16.86 | 16.86 | 12.41 | 17.20 | 18.81 | 17.20 |
| (mm) | | | | | | | | |
| Rotating body | 20.00 | 20.00 | 20.00 | 20.00 | 20.00 | 20.00 | 20.00 | 22.00 |
| outside diameter: | | | | | | | | |
| D₁ (mm) | | | | | | | | |
| Outside | 62.83 | 62.83 | 62.83 | 62.83 | 62.83 | 62.83 | 62.83 | 69.12 |
| circumferential | | | | | | | | |
| length of D₁:L₁ | | | | | | | | |
| (mm) | | | | | | | | |
| Rotating body | 17.50 | 17.50 | 17.50 | 18.00 | 18.00 | 18.00 | 18.00 | 16.00 |
| inside diameter: D₂ | | | | | | | | |
| (mm) | | | | | | | | |
| Inside | 54.98 | 54.98 | 54.98 | 56.55 | 56.55 | 56.55 | 56.55 | 50.27 |
| circumferential | | | | | | | | |
| length of D₂:L₂ | | | | | | | | |
| (mm) | | | | | | | | |
| Insertion member | 16.65 | 16.65 | 16.65 | 17.15 | 17.15 | 17.15 | 17.15 | 15.05 |
| outside diameter: | | | | | | | | |
| D₅ (mm) | | | | | | | | |
| D₂ − 2t = D₆ (mm) | 16.54 | 16.42 | 16.18 | 16.48 | 16.70 | 17.02 | 17.04 | 15.02 |
| Press-fit amount = | 0.11 | 0.23 | 0.47 | 0.67 | 0.45 | 0.13 | 0.11 | 0.03 |
| D₅ − D₆ (mm) | | | | | | | | |
| Elongation (%) = | 17.05 | 25.06 | 18.64 | 18.64 | 61.11 | 16.27 | 6.35 | 27.90 |
| (L₁/L₄ − 1) × 100 | | | | | | | | |
| Difference between | 1.30 | 4.74 | 2.02 | 3.59 | 17.55 | 2.51 | −2.53 | −3.77 |
| inside | | | | | | | | |
| circumferential | | | | | | | | |
| lengths = L₂ − L₄ | | | | | | | | |
| (mm) | | | | | | | | |
| Suitability for | OK | OK | OK | OK | OK | OK | NG | NG |
| condition L₂ ≥ L₄ | | | | | | | | |
| Outside diameter | 20.96 | 21.08 | 21.32 | 21.52 | 21.30 | 20.98 | 20.96 | 22.98 |
| after being | | | | | | | | |
| covered: D | | | | | | | | |
| (Calculated value) | | | | | | | | |
| (mm) | | | | | | | | |
| Measured value of | 20.93 | 21.10 | 21.29 | 21.52 | 21.28 | 20.97 | 20.95 | 22.98 |
| outside diameter: | | | | | | | | |
| D_{S} (mm) | | | | | | | | |
| Runout before being | 0.03 | 0.03 | 0.03 | 0.03 | 0.03 | 0.03 | 0.03 | 0.01 |
| covered (mm) | | | | | | | | |
| Runout after being | 0.05 | 0.05 | 0.05 | 0.05 | 0.05 | 0.05 | 0.31 | 0.44 |
| covered (mm) | | | | | | | | |
| Runout due to | 0.02 | 0.02 | 0.02 | 0.02 | 0.02 | 0.02 | 0.28 | 0.43 |
| being covered | | | | | | | | |
| (mm) | | | | | | | | |
| Determination | OK | OK | OK | OK | OK | OK | NG | NG |

The constitution of Working Example 1 was such that a covering comprising cylindrical warp-knit was used as cylindrical covering, yarn which comprised polyester monofilament and for which the yarn diameter was 0.15 mm being used as knitting yarn, the constitution being warp-knit and cylindrical, thickness of the cylindrical knit being such that thickness t of the cylindrical knit when measured under a constant-pressure load was 0.48 mm, a cylindrical knit fabric for which inside circumferential length L4 of the cylindrical knit fabric was 53.68 mm and width W was 27.8 mm when the cylindrical knit was made to be in intimate contact therewith under a load of 1 kg having been used, the cylindrical rotating body being such that inside diameter D₂=17.5 mm and outside diameter D₁=20 mm, wherein inside diameter D₂ inside circumferential length L2=54.98, the difference (L2-L4) between the inside circumferential length L2 of the rotating body inside diameter and the inside circumferential length L4 of the covering being 1.3 mm, such that L2≥L4.

In addition, the cylindrical-knit covering which was a cylindrical covering was made to cover the rotating body so as to cause approximately 8 mm to respectively protrude from each of the two ends thereof, the covering that had been made to protrude therefrom being folded back at the inner surface of the rotating body, and an insertion member for which the insertion member outside diameter D₅ was 16.65 mm being inserted thereinto such that the press-fit amount was 0.11 mm.

The measured outside diameter D₅ of the covered roller that had been covered with this cylindrical warp-knit was 20.93 mm, which is almost the same as the value of the sum of the rotating body outside diameter D₁ and the covering thickness t. In addition, runout of the covered roller that was covered with this cylindrical knit was such that, as a result of measuring outside diameter under a constant-pressure load, where a state had been achieved such that there was no overlap of the covering at the inner surface, satisfactory results were obtained, runout from the central axis being 0.05 or less.

The constitution of Working Example 2 was such that a covering comprising cylindrical warp-knit was used as cylindrical covering, yarn which comprised Nylon monofilament and for which the yarn diameter was 0.17 mm being used as knitting yarn, the constitution being warp-knit and cylindrical, thickness of the cylindrical knit being such that thickness t of the cylindrical knit when measured under a constant-pressure load was 0.54 mm, a cylindrical knit fabric for which inside circumferential length L4 of the cylindrical knit fabric was 50.24 mm and width W was 26.2 mm when the cylindrical knit was made to be in intimate contact therewith under a load of 1 kg having been used, the cylindrical rotating body being such that inside diameter D₂=17.5 mm and outside diameter D₁=20 mm, wherein inside diameter D₂ inside circumferential length L2=54.98 mm, the difference (L2-L4) between the inside circumferential length L2 of the rotating body inside diameter and the inside circumferential length L4 of the covering being 4.74 mm, such that L2≥L4.

In addition, the cylindrical-knit covering which was a cylindrical covering was made to cover the rotating body so as to cause approximately 8 mm to respectively protrude from each of the two ends thereof, the covering that had been made to protrude therefrom being folded back at the inner surface of the rotating body, and an insertion member for which the insertion member outside diameter D₅ was 16.65 mm being inserted thereinto such that the press-fit amount was 0.23 mm.

The measured outside diameter D₅ of the covered roller that had been covered with this cylindrical warp-knit was 21.10 mm, which is almost the same as the value of the sum of the rotating body outside diameter D₁ and the covering thickness t. In addition, runout of the covered roller that was covered with this cylindrical knit was such that, as a result of measuring outside diameter under a constant-pressure load, where a state had been achieved such that there was no overlap of the covering at the inner surface, satisfactory results were obtained, runout from the central axis being 0.05 or less.

The constitution of Working Example 3 was such that a covering comprising cylindrical warp-knit was used as cylindrical covering, yarn made up of two monofilaments at which the monofilaments comprised polyester and for which the monofilament diameter was 0.15 mm being used as knitting yarn, the constitution being warp-knit and cylindrical, thickness of the cylindrical knit being such that thickness t of the cylindrical knit when measured under a constant-pressure load was 0.66 mm, a cylindrical knit fabric for which inside circumferential length L4 of the cylindrical knit fabric was 52.96 mm and width W was 27.8 mm when the cylindrical knit was made to be in intimate contact therewith under a load of 1 kg having been used, the cylindrical rotating body being such that inside diameter D₂=17.5 mm and outside diameter D₁=20 mm, wherein inside diameter D₂ inside circumferential length L2=54.98 mm, the difference (L2-L4) between the inside circumferential length L2 of the rotating body inside diameter and the inside circumferential length L4 of the covering being 2.02 mm, such that L2≥L4.

In addition, the cylindrical-knit covering which was a cylindrical covering was made to cover the rotating body so as to cause approximately 8 mm to respectively protrude from each of the two ends thereof, the covering that had been made to protrude therefrom being folded back at the inner surface of the rotating body, and an insertion member for which the insertion member outside diameter D₅ was 16.65 mm being inserted thereinto such that the press-fit amount was 0.47 mm.

The measured outside diameter D₅ of the covered roller that had been covered with this cylindrical warp-knit was 21.29 mm, which is almost the same as the value of the sum of the rotating body outside diameter D₁ and the covering thickness t. In addition, runout of the covered roller that was covered with this cylindrical knit was such that, as a result of measuring outside diameter under a constant-pressure load, where a state had been achieved such that there was no overlap of the covering at the inner surface, satisfactory results were obtained, runout from the central axis being 0.05 or less.

The constitution of Working Example 4 was such that a covering comprising cylindrical warp-knit was used as cylindrical covering, yarn made up of two monofilaments at which the monofilaments comprised Nylon and for which the monofilament diameter was 0.17 mm being used as knitting yarn, the constitution being warp-knit and cylindrical, thickness of the cylindrical knit being such that thickness t of the cylindrical knit when measured under a constant-pressure load was 0.76 mm, a cylindrical knit fabric for which inside circumferential length L4 of the cylindrical knit fabric was 52.96 mm and width W was 28.0 mm when the cylindrical knit was made to be in intimate contact therewith under a load of 1 kg having been used, the cylindrical rotating body being such that inside diameter D₂=18.0 mm and outside diameter D₁=20 mm, wherein inside diameter D₂ inside circumferential length L2=56.55 mm, the difference (L2-L4) between the inside circumferential length L2 of the rotating body inside diameter and the inside circumferential length L4 of the covering being 3.59 mm, such that L2≥L4.

In addition, the cylindrical-knit covering which was a cylindrical covering was made to cover the rotating body so as to cause approximately 8 mm to respectively protrude from each of the two ends thereof, the covering that had been made to protrude therefrom being folded back at the inner surface of the rotating body, and an insertion member for which the insertion member outside diameter D₅ was 17.15 mm being inserted thereinto such that the press-fit amount was 0.67 mm.

The measured outside diameter D₅ of the covered roller that had been covered with this cylindrical warp-knit was 21.52 mm, which is almost the same as the value of the sum of the rotating body outside diameter D₁ and the covering thickness t. In addition, runout of the covered roller that was covered with this cylindrical knit was such that, as a result of measuring outside diameter under a constant-pressure load, where a state had been achieved such that there was no overlap of the covering at the inner surface, satisfactory results were obtained, runout from the central axis being 0.05 or less.

The constitution of Working Example 5 was such that a covering comprising cylindrical warp-knit was used as cylindrical covering, stretchable knitting yarn which comprised yarn in which Nylon was used as core yarn and this was covered with urethane fiber being used as knitting yarn, the constitution being warp-knit and cylindrical, thickness of the cylindrical knit being such that thickness t of the cylindrical knit when measured under a constant-pressure load was 0.65 mm, a cylindrical knit fabric for which inside circumferential length L4 of the cylindrical knit fabric was 39.0 mm and width W was 20.8 mm when the cylindrical knit was made to be in intimate contact therewith under a load of 1 kg having been used, the cylindrical rotating body being such that inside diameter D₂=18.0 mm and outside diameter D₁=20 mm, wherein inside diameter D₂ inside circumferential length L2=56.55 mm, the difference (L2-L4) between the inside circumferential length L2 of the rotating body inside diameter and the inside circumferential length L4 of the covering being 17.55 mm, such that L2≥L4.

In addition, the cylindrical-knit covering which was a cylindrical covering was made to cover the rotating body so as to cause approximately 8 mm to respectively protrude from each of the two ends thereof, the covering that had been made to protrude therefrom being folded back at the inner surface of the rotating body, and an insertion member for which the insertion member outside diameter D₅ was 17.15 mm being inserted thereinto such that the press-fit amount was 0.45 mm.

The measured outside diameter D₅ of the covered roller that had been covered with this cylindrical warp-knit was 21.28 mm, which is almost the same as the value of the sum of the rotating body outside diameter D₁ and the covering thickness t. In addition, runout of the covered roller that was covered with this cylindrical knit was such that, as a result of measuring outside diameter under a constant-pressure load, where a state had been achieved such that there was no overlap of the covering at the inner surface, satisfactory results were obtained, runout from the central axis being 0.05 or less.

The constitution of Working Example 6 was such that a covering comprising cylindrical warp-knit was used as cylindrical covering, multifilament (144F/75T) yarn which comprised polyester fiber being used as knitting yarn, the constitution being warp-knit and cylindrical, thickness of the cylindrical knit being such that thickness t of the cylindrical knit when measured under a constant-pressure load was 0.49 mm, a cylindrical knit fabric for which inside circumferential length L4 of the cylindrical knit fabric was 54.04 mm and width W was 28.0 mm when the cylindrical knit was made to be in intimate contact therewith under a load of 1 kg having been used, the cylindrical rotating body being such that inside diameter D₂=18.0 mm and outside diameter D₁=20 mm, wherein inside diameter D₂ inside circumferential length L2=56.55 mm, the difference (L2-L4) between the inside circumferential length L2 of the rotating body inside diameter and the inside circumferential length L4 of the covering being 2.51 mm, such that L2≥L4.

In addition, the cylindrical-knit covering which was a cylindrical covering was made to cover the rotating body so as to cause approximately 8 mm to respectively protrude from each of the two ends thereof, the covering that had been made to protrude therefrom being folded back at the inner surface of the rotating body, and an insertion member for which the insertion member outside diameter D₅ was 17.15 mm being inserted thereinto such that the press-fit amount was 0.13 mm.

The measured outside diameter D₅ of the covered roller that had been covered with this cylindrical warp-knit was 20.97 mm, which is almost the same as the value of the sum of the rotating body outside diameter D₁ and the covering thickness t. In addition, runout of the covered roller that was covered with this cylindrical knit was such that, as a result of measuring outside diameter under a constant-pressure load, where a state had been achieved such that there was no overlap of the covering at the inner surface, satisfactory results were obtained, runout from the central axis being 0.05 or less.

The constitution of Comparative Example 1 was such that a covering comprising cylindrical warp-knit was used as cylindrical covering, the knitting yarn employed at Working Example 1 which was yarn comprising polyester monofilament and for which the yarn diameter was 0.15 mm being used as yarn, the constitution being warp-knit and cylindrical, thickness of the cylindrical knit being such that thickness t of the cylindrical knit when measured under a constant-pressure load was 0.48 mm, a cylindrical knit fabric for which inside circumferential length L4 of the cylindrical knit fabric was 59.08 mm and width W was 30.5 mm when the cylindrical knit was made to be in intimate contact therewith under a load of 1 kg having been used, the cylindrical rotating body being such that inside diameter D₂=18.0 mm and outside diameter D₁=20 mm, wherein inside diameter D₂ inside circumferential length L2=56.54 mm, the difference (L2-L4) between the inside circumferential length L2 of the rotating body inside diameter and the inside circumferential length L4 of the covering being −2.53 mm, such that L4 was the longer of the two.

In addition, the cylindrical-knit covering which was a cylindrical covering was made to cover the rotating body so as to cause approximately 8 mm to respectively protrude from each of the two ends thereof, the covering that had been made to protrude therefrom being folded back at the inner surface of the rotating body, and an insertion member for which the insertion member outside diameter D₅ was 17.15 mm being press-fit and inserted thereinto such that there was overlap of the covering.

The measured outside diameter D₅ of the covered roller that had been covered with this cylindrical warp-knit was 20.95 mm, which is almost the same as the value of the sum of the rotating body outside diameter D₁ and the covering thickness t.

It so happens that runout of the covered roller that was covered with this cylindrical knit was such that, as a result of measuring outside diameter under a constant-pressure load, inside circumferential length L4 of the cylindrical knit being greater than inside circumferential length L2 of the rotating body, due to the fact that the covered roller was formed in a state such that there was occurrence of overlap of the covering at the inner surface, there was a large amount of runout, this being 0.31 from the central axis, it being indicated that the device of Comparative Example 1 would be problematic if an attempt were made to use it as a roller.

The constitution of Comparative Example 1 was such that a covering comprising cylindrical warp-knit was used as cylindrical covering, the knitting yarn employed at Working Example 6 which was multifilament (144F/75T) yarn comprising polyester fiber being used as yarn, the constitution being warp-knit and cylindrical, thickness of the cylindrical knit being such that thickness t of the cylindrical knit when measured under a constant-pressure load was 0.48 mm, a cylindrical knit fabric for which inside circumferential length L4 of the cylindrical knit fabric was 54.04 mm and width W was 28.0 mm when the cylindrical knit was made to be in intimate contact therewith under a load of 1 kg having been used, the cylindrical rotating body being such that inside diameter D₂=16.0 mm and outside diameter D₁=22 mm, wherein inside diameter D₂ inside circumferential length L2=50.27 mm, the difference (L2-L4) between the inside circumferential length L2 of the rotating body inside diameter and the inside circumferential length L4 of the covering being −3.77 mm, such that L4 was the longer of the two.

In addition, the cylindrical-knit covering which was a cylindrical covering was made to cover the rotating body so as to cause approximately 8 mm to respectively protrude from each of the two ends thereof, the covering that had been made to protrude therefrom being folded back at the inner surface of the rotating body, and an insertion member for which the insertion member outside diameter D₅ was 15.05 mm being press-fit and inserted thereinto such that there was overlap of the covering.

The measured outside diameter D₅ of the covered roller that had been covered with this cylindrical warp-knit was 20.98 mm, which is the same as the value of the sum of the rotating body outside diameter D₁ and the covering thickness t.

It so happens that runout of the covered roller that was covered with this cylindrical knit was such that, as a result of measuring outside diameter under a constant-pressure load, inside circumferential length L4 of the cylindrical knit being greater than inside circumferential length L2 of the rotating body, due to the fact that the covered roller was such that a state was formed in which there was occurrence of overlap of the covering at the inner surface, there was a large amount of runout, this being 0.44 from the central axis, it being indicated that the device of Comparative Example 2 would be problematic if an attempt were made to use it as a roller.

Because the cylindrical coverings fabricated by warp-knitting used in the Working Examples and Comparative Examples had the property—as is characteristic of warp-knits—that while tending not to stretch in the longitudinal direction (wale direction) they did stretch in the transverse direction (course direction), they had the property when formed into a cylindrical shape that while tending not to stretch in the axial direction they did stretch in the radial direction, such that intimate contact with the rotating body was satisfactory and they tended not to fray, as a result of which they were coverings that served satisfactorily as coverings. Furthermore, as an example of cylindrical-weave woven fabric, by using nonstretchable yarn (ordinary yarn) as warp yarn in the axial direction, and using stretchable yarn as weft yarn in the radial direction, it will be possible to fabricate a covered roller of good precision which is moreover constituted such that there is no overlap of the woven fabric covering at the inner surface of the rotating body. Moreover, where heat-shrink yarn which makes use of heat is employed, it will be possible by satisfying the present condition to fabricate a roller of good precision.

However, based upon considerations of productivity, a method such as will permit manufacturing to be carried out at normal temperature being preferred, a cylindrical woven/knit fabric in which the covering is a cylindrical knit or is a stretchable cylindrical woven fabric that is stretchable in the radial direction is more preferred. By moreover employing an insertion member having a flange (collar), it will be possible to cause the outside diameter of the flange (collar) to be less than the outside diameter of the covered roller, and, to prevent failure of the apparatus due to damage resulting from wear or the like of the covering, it will be possible to make this greater than the size of the outside diameter of the uncovered rotating body and to control the amount of wear of the covering, and it will also be possible to preemptively prevent failure of the apparatus, and it will be possible detect the lifespan of the covered roller using a simple electrical circuit constitution through use of an electrically conductive member or the like.

As indicated at the Working Examples and Comparative Examples, by adopting a constitution in which a covered roller that is covered with a covering such that the inside circumferential length L4 of the covering is less than the inside circumferential length L2 of the rotating body, a covered roller having a constitution in accordance with the present invention will make it possible to achieve runout precision, which is an important capability of rollers.

Moreover, because roller runout can be a cause of reduced endurance and/or transport precision, uneven wear, vibration, and noise due to vibration, where, as was indicated in the Comparative Examples, a covered roller does not satisfy the condition(s) of the present invention, there will be overlap of the covering at the rotating body inner surface and marked worsening of runout precision, and it will be inadequate in terms of performance as a roller.

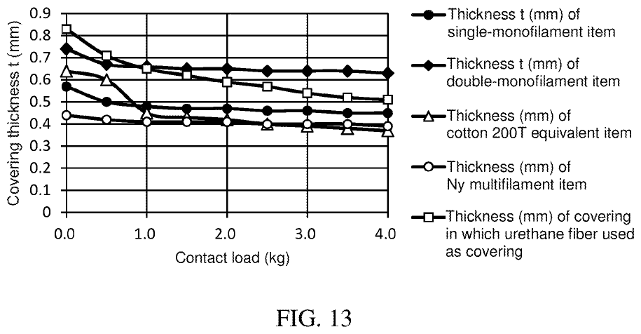

FIG. 13 shows results of ascertaining the change in thickness upon application of a load for a covering in which the covering was of single-monofilament constitution, for a covering that was of double-monofilament constitution, for a covering that employed spun cotton yarn, for a covering that was of multifilament constitution, and for a covering at which a core yarn was covered with urethane fiber. This relationship between contact load and thickness is an important factor in determining outside diameter D₅ at the insertion portion of the insertion member.

As shown in FIG. 13, covering thickness measurement was such that a PG-11 manufactured by Teclock was used to carry out measurement, the situation being such that—except where urethane fiber was used as covering—there was not much change in thickness for loads of 1 kg or higher, and outside diameter D₅ of the insertion member could be easily determined. In contradistinction with respect thereto, because yarn in which urethane fiber constituting elastic fiber is used as covering is capable of elastic deformation, outside diameter D₅ of the insertion member should be set as necessary. By thus causing the covering to be constituted from yarn that does not contain elastic fiber, it will be possible to achieve a situation in which the amount of deformation of the yarn due to load is small, making it possible for press-fitting of the insertion member to be such that this may be a weak press-fit or a strong press-fit, obviating the need for adhesive. It is, however, a constitution that will allow adhesive to be employed when necessary. Moreover, where constituted only by means of a press-fit, as easy replacement of the covering will be possible, only the covering needing to be replaced when the lifespan of the covering is reached, this is also a roller that is conservative of resources.

Thus, in contrast to conventional coverings (woven/knit rollers) that undergo plastic deformation, a covered roller in accordance with the means of the present invention makes it possible to attain roller precision by means of at least a cylindrical covering and a rotating body which is a support member for the covering and an insertion member which is inserted into a rotating body inside diameter D₂ such that the covering intervenes therebetween, and makes it possible for the covering to be secured by an insertion member at the end portion, without use of plastic deformation or a step, or a binding member for binding thereof, and further without the need to provide a cap member for securing thereof. It is furthermore preferred that the covering be constituted in the form of a cylindrical woven/knit fabric comprising woven fabric woven from a single yarn or from a plurality of yarns, or knit fabric knit from a single yarn or from a plurality of yarns.

### Industrial Utility

The present invention, as a result of employment of a cylindrical covering constituted from monofilament, for example, makes it possible to cause coarse mesh openings and steps to be easily constituted by means of monofilament, and permits achievement of a roller which is robust with respect to contamination and clogging of mesh openings. Furthermore, by causing this to be covered with a covering having coarse mesh openings, easy fabrication of a roller having air permeability is made possible thereby. Moreover, by employing a yarn in which urethane or other such rubber elastic fiber covers a core yarn, easy fabrication of a roller having a large force of friction at the surface thereof is made possible thereby. And where multifilament is employed, it will be possible to easily form a roller having fine mesh openings. Moreover, by employing a cylindrical covering employing spun yarn comprising discontinuous fibers, it will be possible to easily fabricate a roller having a soft surface. In addition, by varying the material of the covering, it will be possible to easily fabricate a roller having a low coefficient of friction at the surface thereof where fluoro-type fiber is employed, a heat-resistant covered roller where heat-resistant fiber is employed, a covered roller having high endurance for industrial use where a covering comprising electrical wire from metal fiber is employed, and so forth. Thus, this will make it possible to provide rollers capable of being supplied to a variety of industrial fields.

### EXPLANATION OF REFERENCE NUMERALS

1 Rotating body
2 Covering (cylindrical knit fabric (warp-knit))
3 Insertion member (flangeless-type)
4 Shaft portion
5 Rotating body (cylindrically shaped)
6 Insertion member (flange-type)
7 Retainer ring
8 Shaft
9 Covering (cylindrical woven fabric)
10 Covering (cylindrical woven/knit fabric)
11 Weft yarn employing heat-shrink fiber at cylindrical woven fabric
12 Warp yam at cylindrical woven fabric
13 Heat-shrink jig
114 Weft yarn employing stretch fiber at cylindrical woven fabric
15 Cylindrical knit fabric (warp-knit)
16 Covering
17 Cylindrical covering
18 Glass plate
19 Measurement stage
20 Covered roller
21 Electrically conductive roller
22 Electrically conductive flange (insertion member=flange-type)
23 Idler roller (covered roller)
24 Electrically conductive shaft
25 Bushing
26 Compression spring (for causing contact with roller)
27 Gear
28 Drive roller (electrically conductive roller)
29 Covering for covered roller
30 Bearing

1. In the context of a roller which is shaped so as to be circular or semicircular and which has a rotating shaft at the center of the circle and at which a covering covers a surface of a rotating body that rotates, a covered roller which is covered with the covering and which is characterized in that:
said rotating body has a region at which an insertion member is inserted inside the rotating body that is covered with the covering such that the covering intervenes therebetween;
the covering, a length of which is greater than a width of said rotating body in a width (axial) direction, covers said rotating body so as to cause there to be a region that is made to protrude from said rotating body, an end portion of the covering in the region which has been made to protrude from said rotating body being formed such that heat-shrinking in a radial direction of the covering due to application of heat or contraction of the covering which is stretchable in at least the radial direction causes an inside circumferential length of the end portion of the covering in the region which has been made to protrude from said rotating body to be less than or equal to an inside circumferential length of an inside diameter of the rotating body; and
the roller is such that at least the rotating body, the covering, and the insertion member are made integral, the covering being held to the rotating body surface as a result of the insertion member having been inserted—such that the covering in the protruding portion which has been folded back inside said rotating body intervenes therebetween—under at least press-fit conditions into the region at which the insertion member is inserted inside said rotating body such that the covering intervenes therebetween.

2. In the context of a roller which is shaped so as to be circular or semicircular and which has a rotating shaft at the center of the circle and at which a covering covers a surface of a rotating body that rotates, a covered roller which is covered with the covering and which is characterized in that:
the roller is such that the rotating body is covered by the covering which is woven/knit fabric comprising knit fabric or woven fabric that is cylindrical and that has stretchability in at least a radial direction or woven/knit fabric that undergoes heat-shrinking in the radial direction and which is formed so as to be cylindrical;
said rotating body has a region at which an insertion member is inserted inside the rotating body that is covered with said covering such that said covering intervenes therebetween;
the covering which is said woven/knit fabric comprising knit fabric or woven fabric which is cylindrical covers said rotating body so as to protrude from said rotating body at which insertion takes place, said covering being formed so as to have a circumferential length such as will cause intimate contact of the woven/knit fabric with an inner surface and an outside circumferential surface of the rotating body when the cylindrical woven/knit fabric is made to undergo heat-shrinking due to application of heat, or being formed so as to cause an inside circumferential length of an end portion of the cylindrical woven/knit fabric in a region which protrudes from the rotating body to be less than or equal to an inside circumferential length of an inside diameter of the rotating body as a result of contraction of the woven/knit fabric when stretchability of the cylindrical woven/knit fabric causes the cylindrical woven/knit fabric to be intimate contact with the rotating body surface; and
the roller is such that at least the rotating body, the covering, and the insertion member have been made to be integral, the covering being held to the rotating body surface as a result of the insertion member having been inserted under at least press-fit conditions inside the rotating body such that the covering in the protruding portion which has been folded back inside the rotating body intervenes therebetween.

3. In the context of a roller which is shaped so as to be circular or semicircular and which has a rotating shaft at the center of the circle and at which a covering covers a surface of a rotating body that rotates, a covered roller which is covered with the covering and which is characterized in that:
the roller is such that the rotating body is covered by the covering, the covering being woven/knit fabric comprising knit fabric or woven fabric;
said rotating body has a region at which an insertion member is inserted inside the rotating body that is covered with said covering such that said covering intervenes therebetween;
said covering is formed so as to be cylindrical, the covering being formed from woven/knit fabric having stretchability in at least a radial direction, and being formed so that—before being inserted into the rotating body—an inside circumferential length of the cylindrical covering is less than or equal to an inside circumferential length of an inside diameter of the rotating body in the region at which the insertion member is inserted in the rotating body such that the covering intervenes therebetween; and
the cylindrical covering which has said stretchability covers said rotating body so as to protrude from said rotating body at which insertion takes place, a protruding site of said covering being folded back inside the rotating body, insertion by the insertion member inside the rotating body such that said covering intervenes therebetween being furthermore carried out under at least press-fit conditions, said covering being held to the rotating body surface, the roller being such that at least the rotating body, the covering, and the insertion member have been made integral.

4. In the context of a rotating body which is shaped so as to be circular or semicircular and which has a rotating shaft at the center of the circle and at which a covering comprising woven/knit fabric covers a surface of the rotating body that rotates, a covered roller which is covered with the covering and which is characterized in that:
the covering is woven/knit fabric that is formed so as to be cylindrical, and is cylindrical woven/knit fabric that is formed from monofilament yarn or multi-monofilament yarn, and is cylindrical woven/knit fabric that has stretchability in at least a radial direction; and
said cylindrical covering covers the rotating body such that an end portion of the covering protrudes beyond the width of the rotating body, and is furthermore formed such that contraction pursuant to stretchability of said cylindrical covering causes an outside circumferential length of the end portion of the covering in a region which protrudes from the rotating body to be less than or equal to an inside circumferential length of an inside diameter of the rotating body in a region at which an insertion member is inserted in the rotating body, the covering in said protruding region is folded back inside the rotating body, and insertion by the insertion member in the rotating body such that the covering intervenes therebetween is furthermore carried out under at least press-fit conditions, such that said covering is held to the rotating body surface, and the roller is such that at least the rotating body, the covering, and the insertion member are made integral.

5. The covered roller which is covered with the covering according to claim 1 characterized in that, in the context of the rotating body which is shaped so as to be circular or semicircular and which has the rotating shaft at the center of the circle and at which the covering comprising woven/knit fabric covers the surface of the rotating body that rotates, the insertion member which is inserted under at least press-fit conditions into the rotating body such that the covering intervenes therebetween is a flange-shaped insertion member.

6. The covered roller which is covered with the covering according to claim 5 characterized in that the insertion member which is flange-shaped at the end portion of the rotating body is formed such that an outside diameter at a flange portion of the insertion member is less than an outside diameter of the rotating body which is covered with the covering.

7. The covered roller which is covered with the covering according to claim 6 characterized in that the insertion member which is flange-shaped at the end portion of the rotating body is such that the outside diameter at the flange portion of the insertion member is less than the outside diameter of the rotating body which is covered with the covering, and the outside diameter at the flange portion of the insertion member is equal to the outside diameter of the rotating body before being covered or the outside diameter at the flange portion is greater than the outside diameter of the rotating body before being covered.

8. A method for detecting a lifespan of the covered roller which is covered with the covering according to claim 1 characterized in that the covered roller which is covered with the covering according to claim 1 is used, the insertion member which is flange-shaped at the end portion of the rotating body of said covered roller is formed from a material comprising an electrically conductive member, the rotating body is covered with a cylindrical woven/knit fabric comprising insulating characteristics, an outside diameter at a flange portion of the insertion member which is flange-shaped is less than an outside diameter of the covered rotating body, the outside diameter at the flange portion of the insertion member is greater than the outside diameter of the rotating body before being covered, an electrically conductive member which is independent of said flange is arranged at a location which is opposed to said flange and the rotating body which is covered with the insulating covering and which has the flange of the insertion member which is formed from the material comprising said electrically conductive member, lifespan of the rotating body due to wear of the covering of the covered rotating body is detected as lifespan of the covered roller which is covered with the insulating covering upon detection of an electrical signal pertaining to electrical continuity occurring due to contact between the flange of the insertion member which is formed from the material comprising said electrically conductive member and the electrically conductive member which is independent of said flange which is arranged at the location which is opposed to the flange of the insertion member which is formed from the material comprising said electrically conductive member.
